(19) United States
(12) Patent Application Publication
(10) Pub. No.: US 2015/0239287 A1
(43) Pub. Date: Aug. 27, 2015

(54) VEHICLE RIM PROTECTOR

(71) Applicant: Rodney Young, Hendersonville, NC (US)

(72) Inventor: Rodney Young, Hendersonville, NC (US)

(21) Appl. No.: 14/186,080

(22) Filed: Feb. 21, 2014

(51) Int. Cl. B60B 7/00; B60B 7/06; B60B 7/02

(52) U.S. Cl. CPC B60B 7/0073; B60B 7/02; B60B 7/06; B60B 2900/541

(57) ABSTRACT

A vehicle rim protector to shield a portion of a vehicle tire comprising a domed shield, where the domed shield includes an exterior surface and an interior surface; a peripheral edge of the domed shield; and a positioning means attached to the domed shield, where the positioning means secures the domed shield above a tire rim. The vehicle rim protector may include a handle to enable the user to hold the domed shield above the rim. Alternatively, the domed shield may include a set of clips to fasten the rim protector directly to the rim.

### BACKGROUND OF THE INVENTION

1. Field of the Invention

The present invention relates to a device to protect vehicle rims from spray and debris when cleaning the tires.

2. Description of Related Art

Vehicle owners, especially vehicle enthusiasts, commonly detail their cars, taking time to thoroughly clean and polish the interior, exterior and under the hood. While cleaning the interior, care is taken to vacuum, wipe and shine each surface even below the seats and next to the console. While cleaning the exterior, all surfaces are scrubbed and polished to shine and remove any visible markings like scratches or prints. The task may be time consuming but the final result of a clean and spotless vehicle is rewarding.

Special care is typically taken when washing the wheels to ensure that both the tire and the rims are clean and shining. Cleaning the vehicle wheels may be time consuming and tedious because extra effort is required to prevent marking or dirtying the already washed rim. The user must also pay attention as to not allow the cleaning or shining sprays from getting into the wheel itself, because this may be damaging to the interior components like the brake rotors and pads. Often after the user sprays the tires they must return to detail wipe the rims to remove the overspray and buildup accumulated during washing.

Therefore it would be beneficial in the art to provide a shield that covers the wheel rims, thereby protecting the rims from spray while cleaning the tires. Additionally it would be desirable in the art to provide a shield that is easily positional and light weight so that the user may transition from one tire to the next effortlessly.

### SUMMARY OF THE INVENTION

In view of the foregoing disadvantages inherent in the prior art, the general purpose of the present invention is to provide a vehicle rim protector to shield a portion of a vehicle tire, configured to include all of the advantages of the prior art, and to overcome the drawbacks inherent therein.

Accordingly, an object of the present invention is to provide a vehicle rim protector that shields the vehicle rim from cleaning and shining spray when detailing the wheels.

Another object of the present invention is to provide a vehicle rim protector that includes a positioning means to either hold or fasten the protector above the vehicle rim.

To achieve the above objects, in an aspect of the present invention, a vehicle rim protector is described comprising a domed shield, where the domed shield includes an exterior surface and an interior surface; a peripheral edge of the domed shield; and a positioning means attached to the domed shield, where the positioning means secures the domed shield above a tire rim. The vehicle rim protector may include a handle to enable the user to hold the domed shield above the rim. Alternatively, the domed shield may include a set of clips to fasten the rim protector directly to the rim.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 depicts a perspective view of a vehicle rim protector in accordance with an exemplary embodiment of the present invention;

FIG. 2(A) depicts a front view of a vehicle rim protector with a tire in accordance with an exemplary embodiment of the present invention; and

FIG. 2(B) depicts a front view of a vehicle rim protector over a tire in accordance with an exemplary embodiment of the present invention.

Like reference numerals refer to like parts throughout the description of several views of the drawings.

### DETAILED DESCRIPTION OF THE DRAWINGS

The present invention relates to a device to protect vehicle rims from spray and debris when cleaning or shining the tires. The present invention provides a vehicle rim protector for use as a shield over a vehicle rim. The vehicle rim protector comprises a dome shaped shield that a user positions over the rim. The shield may be held in place by holding onto a handle on the outer surface. Alternatively, a set of clips may be attached to an inner surface of the shield to fasten the protector directly to the rim. By utilizing the vehicle rim protector the rim and the interior components of the wheel are protected from excess buildup giving the user optimal vehicle performance.

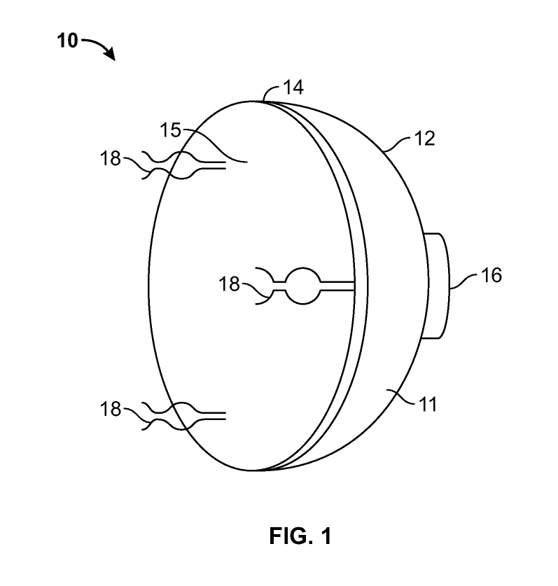

Turning now descriptively to the drawings, referring to FIG. 1, a perspective view of a vehicle rim protector 10 is shown in accordance with an exemplary embodiment of the present invention. The vehicle rim protector 10 includes a domed shield 12 which gets positioned over a vehicle rim. The domed shield 12 is circular with a peripheral edge 14. The domed shield 12 includes an exterior surface 11 and an interior surface 15. The vehicle rim protector 10 may be made from aluminum, plastic or a similar lightweight and durable material.

On the exterior surface 11 may be a handle 16 which the user grasps to position the domed shield 12 over the rim. Alternatively, the interior surface 15 of the domed shield 12 may include a set of attachment means 18. The attachment means 18 may be clips or hooks to fasten the domed shield 12 to the rim of the wheel. The attachment means 18 may be attached directly to the interior surface 15 or they may be attached beneath the peripheral edge 14. Both the handle 16 and the attachment means 18 may be removable to enable the user to select between how they wish to use the vehicle rim protector 10.

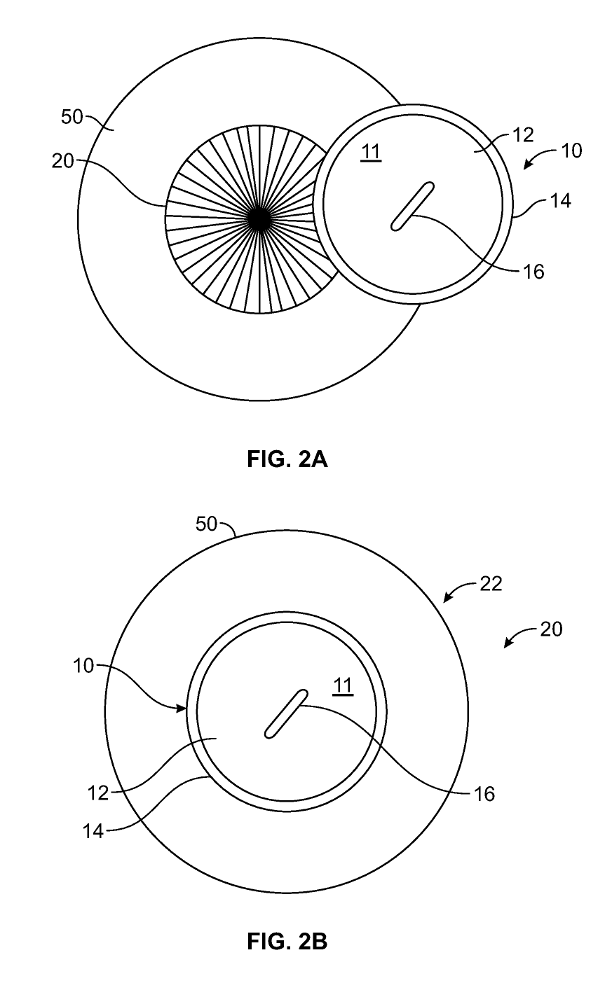

Referring now to FIG. 2 (A) the vehicle rim protector 10 is shown with a vehicle tire 50 in accordance with an exemplary embodiment of the present invention. The vehicle rim protector 10 is positioned above the rim 52 when the user is cleaning or shining the tire 50. FIG. 2(B) illustrates the vehicle rim protector 10 with the domed shield 12 positioned above the rim. The domed shield 12 is either held in place by the user holding the handle 16 or by securing the set of attachment means to the rim.

With the vehicle rim protector 10 the user is able to shield the rims from the spray 22 of a cleaning or shining container 20. The user holds or clips the domed shield 12 to prevent the spray 22 from getting on the already cleaned rim. This way the user is afforded peace of mind that they will not have clean the rim again and that the internal components of the tire, like the brake rotors and pads, remain free of buildup and debris.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A vehicle rim protector to shield a portion of a vehicle tire comprising:
a. a domed shield, where the domed shield includes an exterior surface and an interior surface;
b. a peripheral edge of the domed shield; and
c. a positioning means attached to the domed shield, where the positioning means secures the domed shield above a tire rim.

2. The vehicle rim protector according to claim 1, where the domed shield is circular.

3. The vehicle rim protector according to claim 1, where the positioning means is a handle on the exterior surface of the domed shield.

4. The vehicle rim protector according to claim 3, where the handle is removable.

5. The vehicle rim protector according to claim 1, where the positioning means is a set of attachment means positioned to the interior surface of the domed shield.

6. The vehicle rim protector according to claim 5, where the set of attachment means is one of at least hooks or clips.

7. The vehicle rim protector according to claim 5, where the set of attachment means is attached beneath the peripheral edge.

8. The vehicle rim protector according to claim 5, where the attachment means are removable.
